(19) United States
(12) Patent Application Publication
(10) Pub. No.: US 2014/0138366 A1
(43) Pub. Date: May 22, 2014

(54) SELF-ADJUSTING WIRE FOR WELDING APPLICATIONS

(71) Applicant: GM Global Technology Operations LLC, Detroit, MI (US)

(72) Inventors: Jing Zhang, Shanghai (CN); Pei-Chung Wang, Troy, MI (US); David Yang, Shanghai (CN)

(73) Assignee: GM GLOBAL TECHNOLOGY OPERATIONS LLC, Detroit, MI (US)

(21) Appl. No.: 14/076,639

(22) Filed: Nov. 11, 2013

(30) Foreign Application Priority Data
Nov. 16, 2012 (CN) 2012-10462808.2

(51) Int. Cl. B23K 35/22

(52) U.S. Cl. CPC B23K 35/22
USPC 219/137 WM; 219/145.1

(57) ABSTRACT

Disclosed are self-adjusting wires, methods of making these self-adjusting wires, and thermal joining processes (such as gas metal arc welding or laser brazing) and other processes using these self-adjusting wires. The wires have a core of a metal or metal alloy suitable as a joining material in the joining process and an exterior layer of a shape-memory alloy, which may be continuous about the exterior of the core or discontinuous such as a longitudinal strip or strips. The shape-memory alloy of the self-adjusting wire is “trained” to a straight-wire shape in its austenite phase. In using the self-adjusting wire in a process, a bent end of the self-adjusting wire is straightened by heating the self-adjusting wire above the austenite phase transition temperature of the shape-memory alloy.

### CROSS-REFERENCE TO RELATED APPLICATIONS

This application claims the benefit and priority of Chinese Patent Application No. 201210462808.2, filed Nov. 16, 2012. The entire disclosure of the above application is incorporated herein by reference.

### FIELD OF THE INVENTION

The present invention relates to welding and joining methods and materials and articles used in such methods. In another aspect, the invention relates to processes involving alignment of wires and such.

INTRODUCTION TO THE DISCLOSURE

This section provides information helpful in understanding the invention but that is not necessarily prior art.

Gas metal arc welding (GMAW), also often called metal inert gas (MIG) welding, is an arc welding process using a continuous, consumable weld or filler wire as electrode. In gas metal arc welding, the consumable wire electrode passes through a welding gun or torch and out a torch contact tip, which is made of a conducting metal like copper alloys. Electric potential applied between the contact tip and the metal work piece to be welded results in a current in the wire which supports an arc between the wire end and a metal work piece. The arc is shielded from the atmosphere by a flow of a gas or a gas mixture, often an inert gas mixture, with metal transferred to the work piece through the arc from the consumable wire electrode. Laser brazing also feeds a filler wire to a welding site, where it is melted by direct laser irradiation. The drops of molten wire bridge a joint between two work pieces.

Bent wires and wire-to-workpiece misalignment are common occurrences during arc welding, laser brazing, arc brazing, TIG welding with filler wire, and other joining processes or thermal processes, that use filler wire. The misalignment of the wire with respect to the weld seam can cause an unstable joining process and result in poor weld quality. Therefore, manual adjustments are often needed to straighten the bent wire, delaying production. Bent wires and wire-to-workpiece misalignment can be a problem in other processes as well, for example when wire is threaded through a hole or when wires are welded together.

### SUMMARY OF THE DISCLOSURE

This section provides a general summary rather than a comprehensive disclosure of the full scope of the invention or all of its features.

Disclosed are self-adjusting wires, methods of making these self-adjusting wires, and thermal joining processes (such as gas arc welding, laser brazing, arc brazing, TIG welding, and other joining processes) and other process such as wire-to-wire welding and wire threading in which heat may be used to straighten or align these self-adjusting wires. The wires have a core of a metal or metal alloy, such as one suitable as a joining material in the joining process, and an outer layer of a shape-memory alloy. The outer layer may have any configuration, for example it may be a cladding, a continuous strip winding helically about the core, a mesh, or a discontinuous layer such as a longitudinal strip or strips of a shape-memory alloy. The shape-memory alloy of the self-adjusting wire is “trained” to a straight-wire shape at a training temperature in its austenite phase; in the processes, the wire is heated above its austenite phase transition temperature so that any bend in the self-adjusting wire is straightened by the shape-memory alloy resuming its trained, straight-wire shape.

The self-adjusting wire may be made by applying or fixing a layer of the shape-memory alloy to a core of a metal or metal alloy, such as a joining metal or metal alloy, such as by applying or by fixing a continuous layer or one or more longitudinal strips of the shape-memory alloy to the exterior of a core of a metal or metal alloy that generally will not be a shape-memory alloy and may be, for instance, a joining metal or metal alloy to make a composite with a joining or other metal or metal alloy core and a shape-memory alloy exterior layer. The composite having a joining material or other metal core and shape-memory alloy exterior layer may be subjected to further forming operations, such as drawing, to obtain a desired cross-sectional shape and cross-sectional dimensions (e.g., diameter or width) for the final self-adjusting wire. The outer layer, whether continuous or discontinuous around the circumference of the wire or strips, may be of various regular or irregular shapes and thicknesses, including claddings, meshes, braids, helical strips, and may be of regularly or irregularly varying thickness. The final wire having the joining metal or metal alloy core and the shape-memory alloy outer layer (e.g., cladding or exterior longitudinal strips) is then trained to a straight-wire shape by heating the wire above the martensite to austenite phase transition temperature (which is also referred to in this description as simply as the “phase transition temperature” or “austenite phase transition temperature”) for the shape-memory alloy and keeping the heated wire length straight until it has cooled below the austenite to martensite transition temperature. If the self-adjusting wire is bent when the shape-memory alloy is in its martensite phase, the self-adjusting wire straightens again when heated to above the phase transition temperature during the thermal processes (e.g., the joining process or alignment process) in which it is used.

Further disclosed is a thermal joining process in which the self-adjusting wire is used as a filler in joining two metal work pieces. In the joining process, the self-adjusting wire reaches a temperature above the shape-memory alloy martensite to austenite phase transition temperature, which causes a bend in the self-adjusting wire to straighten. In various embodiments, the joining process is a gas metal arc welding process, in which the self-adjusting wire is fed through a torch and out of a torch contact tip. Electric potential is applied between the contact tip and a metal work piece to be welded, causing a current in the self-adjusting wire that heats the wire leaving the torch to a temperature above the shape-memory alloy phase transition temperature, with the result that a bend in the wire is straightened.

In other embodiments, a heat source is used to straighten an end or part of the self-adjusting wire by heating the wire above the martensite to austenite phase transition temperature of the shape-memory alloy, causing the wire to straighten and enabling proper positioning or alignment of the wire.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

The terms “comprises,” “comprising,” “including,” and “having,” are inclusive and therefore specify the presence of stated items, but do not preclude the presence of other items. As used in this specification, the term “or” includes one or any and all combinations of two or more of the associated listed items. When the terms first, second, third, etc. are used to differentiate various items from each other, these designations are merely for convenience and do not limit the items.

Further areas of applicability will become apparent from the detailed description and illustrative specific examples following.

### BRIEF DESCRIPTION OF THE DRAWINGS

The drawings illustrate selected embodiments but not all possible implementations or variations described in this disclosure.

FIGS. 1a and 1b are cross-sectional views of illustrative embodiments of self-adjusting wires;

FIG. 2 is a schematic elevation of an embodiment of a GMAW system using the self-adjusting wires of FIGS. 1a and 1b;

FIG. 3 is a perspective view of a torch nozzle for the GMAW system of FIG. 2;

FIG. 4 illustrates a representative response of a self-adjusting wire to heat at the beginning of a GMAW process;

FIG. 5 is a graph of recovery stress versus temperature for illustrative embodiments of self-adjusting wires;

FIG. 6 illustrates a representative response of a self-adjusting wire to heat at the beginning of a laser welding process; and

FIG. 7 is a schematic diagram of a configuration for capacitor discharge projection welding of the self-adjusting wires of FIGS. 1a and 1b.

### DETAILED DESCRIPTION

A detailed description of exemplary, nonlimiting embodiments follows.

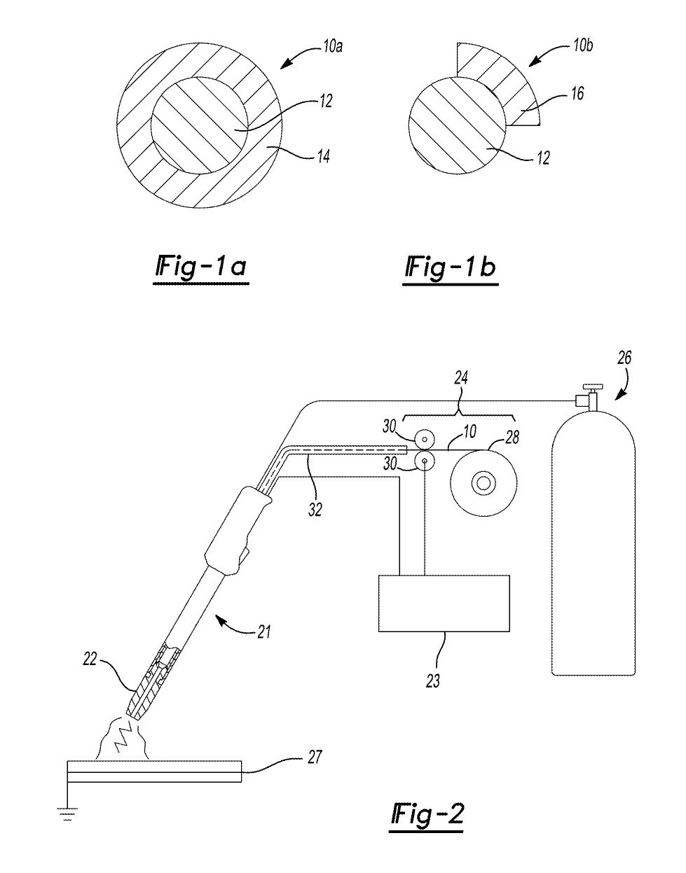

FIGS. 1a and 1b illustrate two example configurations for self-adjusting wires. Self-adjusting wire 10a has a core 12 of a metal or metal alloy suitable as a joining material, e.g., as a weld or filler material, and a cladding or outer layer 14 of a shape-memory alloy. The outer layer 14 of FIG. 1a is a layer or cladding that is continuous about the circumference of core 12. The layer 14 is generally in the shape of a cylinder or tube around and adjacent the outer surface of core 12. Self-adjusting wire 10b again has a core 12 of a metal or metal alloy suitable as a joining material, e.g., as a weld or filler material, but outer layer 16 of a shape-memory alloy is a layer that does not fully surround the circumference of the core 12. In various embodiments, outer layer 16, while not completely covering the circumference of core 12, may cover more or less of core 12 than is shown in FIG. 1b. FIG. 1b shows incomplete outer layer 16 formed by a single longitudinal strip of the shape-memory alloy, but in various other embodiments, incomplete outer layer 16 may be formed by a plurality of longitudinal strips of the shape-memory alloy that cover less than all of the surface of core 12 and may be adjacent or spaced from one another. The shape memory layer or strips may or may not be of uniform thicknesses along their lengths, circumferences, or widths; and the shape-memory alloy strips may or may not be of uniform thicknesses relative to one another (when the self-adjusting wire has more than one shape-memory alloy strip).

FIGS. 1a and 1b show exemplary self-adjusting wires that have generally circular cross-sections. In other embodiments, the self-adjusting wires may have a broad range of cross-sections, including other generally geometric shapes such as elliptical, square, rectangular or other polygonal cross-sectional outer perimeter shapes as well as irregular cross-sectional shapes, all of which may have uniform widths or diameters that do not vary along the wire length or may have non-uniform widths or diameters that do vary, either regularly (e.g., sinusoidally) or irregularly, along the wire length. The outer layer (e.g., cladding or strips) may be of various regular or irregular shapes and thicknesses, including meshes, braids, helical strips, and layers of regularly or irregularly varying thicknesses. When a cladding of the shape-memory alloy is used, it may be a continuous layer as shown if FIG. 1a or a mesh or other layer having holes or discontinuities. In another variation, a strip or strips may be spirally or helically wound about the core. A cladding, whether continuous or mesh, or a layer wound about the core preferably fits snugly against the core or is attached to the core.

Nonlimiting examples of conductive metals and metal alloys suitable for the core as a GMAW consumable electrode material or for other thermal joining processes include, for example, iron, iron-carbon alloys, copper, and copper alloys. Further examples are shown in Table 1, below. Iron-carbon alloys may include other alloying elements and, as a nonlimiting example, iron-carbon alloys include steels. In various example embodiments, the electrode material may be a steel such as a low-carbon steel, a low-alloy steel, a medium-carbon steel, or a stainless steel.

The self-adjusting wire also has an outer layer of a shape-memory alloy (whether continuous around the core or as a strip or strips or other discontinuous configuration), such as layer 14 or layer 16. Shape-memory alloys are alloys that exhibit a reversible temperature-dependent diffusionless transition between its martensite and austenite phases. Shape-memory alloys have a low temperature or martensite phase and a high temperature parent or austenite phase. A shape-memory alloy may be trained in its higher-temperature austenite phase to have a permanent shape. If the trained shape-memory alloy is then deformed when in the martensite phase, as it is heated the deformed shape-memory alloy will transform to the parent or austenite phase, returning to the permanent shape. The temperature at which the transformation starts is often referred to as the austenite start temperature (Aₛ); the temperature at which this phenomenon is complete is called the austenite finish temperature (A_{f}). For the purposes of this invention disclosure, A_{f} will be called the martensite to austenite transition temperature or phase transition temperature. The martensite to austenite transition temperature, at which the shape-memory alloy recovers its permanent shape when heated, can be adjusted by slight changes in the composition of the alloy and through heat treatment. The shape recovery process can occur over a range of just a few degrees or over a wider temperature range, and the start or finish of the transformation can be controlled to within a degree or two depending on the desired application and alloy composition.

Nonlimiting examples of suitable shape-memory alloys are alloys of zinc, copper, gold, iron, aluminum or nickel, optionally with other metals. Specific, nonlimiting examples include copper-zinc-aluminum-nickel alloys, copper-aluminum-nickel alloys, nickel-titanium alloys, iron-nickel alloys, iron-manganese-silicon alloys, and copper-zinc alloys.

Table 1 lists nonlimiting examples of combinations of shape-memory alloys with wire core materials. As shown by the examples in Table 1, when the self-adjusting wire is used in thermal joining processes such as welding processes the core typically has the same or a similar metal composition as the workpiece substrate with which it is used. In one example of this, when the substrate is a steel, the core can be a steel of the same alloy composition or with selected higher or lower content of an alloying metal as needed to produce a weld having desired characteristics or properties. However, the core may instead be a metal or alloy different from the workpiece substrate, and one nonlimiting example of this is use of a self-adjusting wire having a nickel-based core in welding a cast iron substrate.

TABLE 1
Shape-memory alloy types suitable for wire core and
corresponding substrate

| Shape-memory alloy | Wire core and corresponding substrate |
|---|---|
| Cu—Al—Ni 14-14.5 wt. % | Copper alloys, Aluminum alloys, Nickel- |
| Al and 3-4.5 wt. % Ni | based alloys |
| Cu—Sn approx. 15 at. % Sn | Copper alloys, Aluminum alloys |
| Cu—Zn 38.5/41.5 wt. % Zn | Copper alloys, Aluminum alloys |
| Cu—Zn—X (X = Si, Al, Sn) | Copper alloys, Aluminum alloys |
| Fe—Pt approx. 25 at. % Pt | Steels, Cast irons |
| Fe—Mn—Si | Steels, Nickel-based alloys |
| Co—Ni—Al | Cobalt alloys, Titanium alloys, |
| | Nickel-based alloys |
| Co—Ni—Ga | Cobalt alloys, Titanium alloys, |
| | Nickel-based alloys |
| Ni—Fe—Ga | Nickel-based alloys, Steels, Cast irons |
| Ti—Pd in various | Titanium alloys |
| concentrations | |
| Ni—Ti (~55% Ni) | Nickel-based alloys, Titanium alloys, |
| | Aluminum alloys, Steels, Cast irons |
| Ni—Ti—Nb | Nickel-based alloys, Titanium alloys, |
| | Aluminum alloys, Steels, Cast irons |
| Ni—Mn—Ga | Nickel-based alloys, Aluminum alloys, |
| | Steels, Cast irons |

As a nonlimiting example, shape-memory alloys may be made by casting, using vacuum arc melting or induction melting to minimize impurities in the alloy and ensure good mixing of the alloyed metals. The cast ingot may then be hot rolled into longer sections, then drawn into a wire, which may then be flattened to form a sheath or cladding or to be shaped or attached as a longitudinal strip or in another configuration along the outside of core 12. Strips of the shape-memory alloy may be formed in other ways not involving drawing the material into a wire.

The self-adjusting wire 10a may be made by any of a number of known methods. In an example, the metal or metal alloy core may be made by a wire drawing process, after which the shape-memory alloy may then be placed on the core as a cladding, sheath, or a strip or strips along the length of the core. In a first exemplary method, analogously to a method described in U.S. Pat. No. 3,702,497, the entire disclosure of which is incorporated herein by reference, a cladding or outer layer 14 of a shape-memory alloy may be extrusion-bonded around a core 12 of the metal or metal alloy suitable as a joining material, then may be further drawn to a desired final diameter to produce self-adjusting wire 10a. In a second exemplary method, a strip of the shape-memory alloy is first bent to form an open tube. A wire of the metal or metal alloy suitable as a joining material is inserted to form core 12 and the tube is closed using rollers, before being tungsten inert gas (TIG) welded to form a tube as outer layer 14 around the core 12. The inert gas may be, for example, argon. Further drawing and thermal treatments may be used to bond the two materials if desired. In a third exemplary method, analogously to a method described in U.S. Pat. Pub. No. 2006/0076336, the entire disclosure of which is incorporated herein by reference, a strip of the metal or metal alloy suitable as a joining material is bent to form a core 12 having a butt or lap seam and a second strip made of the shape-memory alloy is wrapped around core 12 as outer layer 14. The wrapped outer layer 14 may be wrapped tightly to leave no gaps as shown in FIG. 1a. It is also contemplated that the second strip made of the shape-memory alloy may form an incomplete layer 16 on the core 12 as shown in FIG. 1b. The wrapped strips may then be drawn to a desired diameter for final self-adjusting wire 10a or 10b. The drawing step may be replaced by rolling if desired. A still further exemplary method that may be used to apply a strip or strips 16 of shape-memory alloy to a core 12 of the conductive metal or metal alloy electrode material uses a rolling mill to squeeze the strip or strips 16 on the core 12, followed again by drawing the wire to a desired diameter for the self-adjusting wire.

As examples of certain specific embodiments, a shape-memory alloy selected from Fe—Ni and Fe—Mn—Si alloys may form outer layer 14 or strip or strips 16 on a steel core 12; a shape-memory alloy selected from Ti—Ni and Cu—Zn alloys may form outer layer 14 or strip or strips 16 on an aluminum alloy core 12 for self-adjusting wires. Other particular self-adjusting wires may be made by combining materials as shown in the rows of Table 1.

Continuing with the exemplary configurations of FIG. 1a and FIG. 1b, the shape-memory alloys are trained to a straight-wire shape at a training temperature above the martensite to austenite phase transition temperature for the shape-memory alloys. The phase transition temperature is below a joining temperature reached during the thermal joining process so that, when the phase transition temperature is reached during the thermal joining process, any bend in the self-adjusting wire is straightened by action the shape-memory alloy returning to its trained straight-wire shape.

The shape-memory alloy may be trained before, during, or after it is incorporated into the self-adjusting wire. After being trained to a straight shape, the shape-memory alloy layer, strip, strips of the self-adjusting wire may undergo a cold working process or processes, for example drawing, coiling, or an undesired deformation to a temporary shape. When the self-adjusting wire is heated during the thermal joining process, the thermally-induced shape recovery force of the shape-memory alloy in reaching and exceeding its phase transition temperature straightens the self-adjusting wire to make it return to the straight, permanent shape. Any of various specific methods known for training the shape-memory alloys may be used. In one such common method for Ti—Ni shape-memory alloys, for example, after any desired cold working (such as forming the shape-memory alloy into a wire or strips and optionally attaching the shape-memory alloy to the core metal or metal alloy) the shape-memory alloy is heated at 400-500° C. for a period of time (the “preservation” time) from several minutes to several hours. The Ti—Ni shape-memory alloy is then quenched, for example with water. A longer preservation time produces a higher phase transition temperature. In a specific example, Ti-50.7Ni at. % alloy that is treated by heating to 500° C. and held at that temperature for 30 minutes has a phase transition temperature that is about 32° C. The heating may be carried out in a heat treatment furnace, for example. As another example, Ti—Ni shape-memory alloys may also be trained by annealing at 800° C., then the Ti—Ni shape-memory alloys may be cold worked to a desired wire shape, then the wire may be subjected to a low-temperature training period by heating at 200-300° C. for a preservation time of from several minutes to tens of minutes before quenching. In still another example of a process of training the shape-memory alloy, which may be used with a Ti—Ni shape-memory alloy having a Ni content higher than 50.5 at. %, the shape-memory alloy may be aged at a temperature of from 800-1000° C., then rapidly cooled to a training temperature of about 400° C. and kept at the training temperature for several hours before being quenched. In a further example, CuZnAl alloys may be cold worked, then trained at 800-850° C. for about 10 minutes, followed by quenching in oil at a temperature of about 150° C. for about 2 minutes. If part of the self-adjusting wire before training, the shape-trained shape-memory alloy forms the outer layer on the metal or metal alloy core after training. The particular training process used will depend upon factors such as the specific shape-memory alloy and can be optimized by routine experimentation.

The self-adjusting wire may have a diameter or width or, in the case of a self-adjusting wire with one or more longitudinal strips of the shape-memory alloy, a maximum diameter or width of from about 0.8 mm to about 2 mm; in a narrower range, the diameter or width may be from about 1 mm to about 1.8 mm or from about 1 mm to about 1.5 mm. The core of metal or metal alloy joining material may have a diameter or width of from about 0.6 mm to about 1.6 mm; in a narrower range, the core may have a diameter or width of from about 0.7 mm to about 1.5 mm or from about 0.8 mm to about 1.4 mm. The cladding, strip or strips, or other layer of shape-memory alloy may have a thickness or thicknesses of from about 0.2 mm to about 0.4 mm. The recovery force of the shape-memory alloy (which may be determined from the particular shape-memory alloy composition, the extent of deformation, and the temperature) is selected to exceed the resistance to deformation of the core. Thus, the material for the shape-memory alloy and the amount of shape-memory alloy used in making the self-adjusting wire may be selected based on the core material, the extent of bending that may occur, and the temperature the wire can reach during use. For example, because cores of aluminum alloys have relatively low resistances of deformation compared with steels, the thickness of the shape-memory alloy layer can be smaller for a self-adjusting wire with an aluminum alloy core than it can with a steel core. The particular type and thickness of shape-memory alloy used in making a self-adjusting wire for a particular application can be determined from such factors or by straightforward experimentation. In one specific example, an aluminum alloy core with the diameter of 0.8 mm can be easily straightened by a shape memory strip with a thickness of 0.4 mm.

Self-adjusting wire 10 is useful as a joining or filler wire in a thermal joining process such as arc welding or laser brazing in which the wire is melted into a seam between two or more metal articles or work pieces. The molten wire material welds or brazes the metal articles.

Self-adjusting wire 10 may be used in a gas metal arc welding (GMAW) process, in which self-adjusting wire 10 is used as a consumable wire electrode. An electric arc is formed between self-adjusting wire 10 acting as electrode and the work piece to be welded. In gas metal arc welding, the consumable electrode is normally positive and the work piece is negative. FIG. 2 is a schematic elevation of a GMAW system, particularly illustrating a torch, power supply, self-adjusting wire feed unit, and a shielding gas supply tank. The GMAW system has a torch (or welding gun) 21 having a nozzle 22, a power supply 23, a wire feed unit 24 configured to feed self-adjusting wire 10 to the torch 21, and a shielding gas supply 26. The welding torch 21 may be oriented so as to maintain a consistent torch tip-to-work distance from pre-positioned work pieces 27. Self-adjusting wire feed unit 24 includes a wire reel 28 of wound self-adjusting wire 10. Wire feeding wheels 30, powered by power supply 23, draw self-adjusting wire 10 from wire reel 28 and push self-adjusting wire 10 through wire feeding pipe 32 to the welding torch 21.

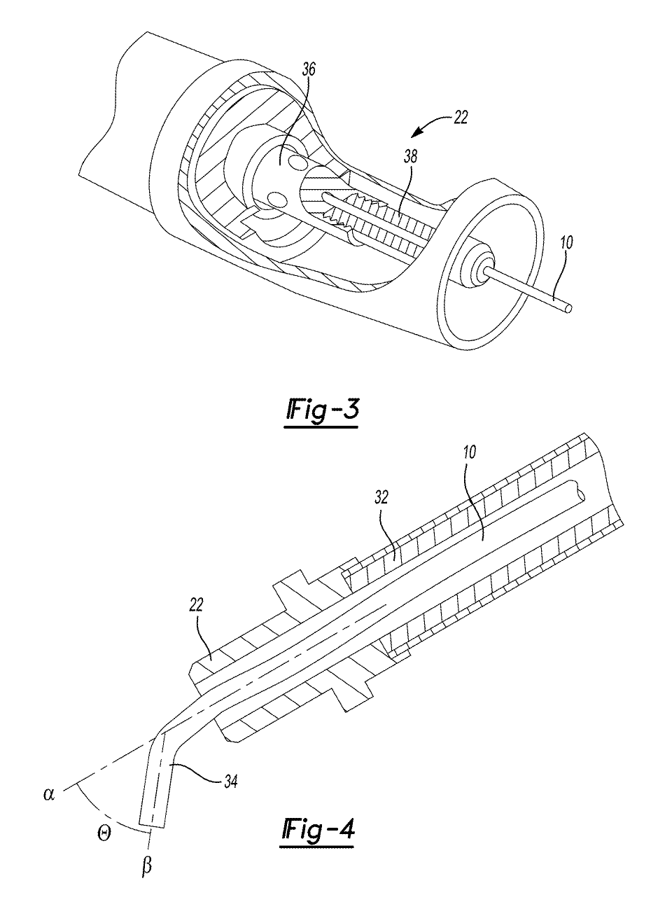

As shown in FIGS. 2 and 3, the welding torch gun nozzle 22 includes an electrically energized contact tip 38 that is axially aligned inside the gun nozzle 22 and configured to charge by contacting the self-adjusting wire 10. Welding power to form the arc is supplied by power supply 23 connected between the welding torch 21 and the work piece 27. The welding torch 21 transfers power to the self-adjusting wire 10, which acts as a consumable electrode, through the contact tip 38. Contact tip 38 which makes electrical contact with the self-adjusting wire 10 through a contact surface. The contact surface may extend the length of the contact tip 38 or may extend over just a portion of the length of the contact tip 38. The applied voltage between the charged self-adjusting wire 10, acting as electrode, and work piece 27 produces an intermediate electric arc.

The work piece includes a joint to be welded. During the welding process, the self-adjusting wire 10 is melted by heat produced by its internal resistance and heat transferred from the arc. Molten droplets from the self-adjusting wire are transferred to the work piece 27. The drops of molten self-adjusting wire carried across the arc gap to the work piece 27 form a weld pool on work piece 27, which form a weld bead as the metal solidifies. The mode of metal transfer is dependent upon the operating parameters such as welding current, voltage, wire size, wire speed, electrode extension and the protective gas shielding composition. The known modes of metal transfer include short circuit, globular transfer, axial spray transfer, pulse spray transfer and rotating arc spray transfer. In an embodiment, a substantially constant arc voltage is maintained between the self-adjusting wire electrode and the work piece. In another embodiment, the voltage between the electrode and the work piece may be pulsed. In an embodiment, the arc voltage is greater than 15 V. In other embodiments, the arc voltage is between about 15V and about 50V or between about 15V and about 40 V. The welding current may be from about 50 amperes up to about 600 amperes or from about 50 amperes up to about 500 amperes. The heat of the arc may also melt a portion of the work piece, contributing to formation of a weld pool. A substantially uniform arc length may be maintained between the melting end of the self-adjusting wire electrode and the weld pool by feeding the electrode into the arc as fast as it melts. The welding current may be adapted to the rate as which the self-adjusting wire 10 is fed through the welding gun 21.

Shielding gas from gas supply 26 is diffused by shielding gas diffuser 36 to protect the welding area from atmospheric gases. The shielding gas forms an arc plasma that shields the arc and molten weld pool. Nonlimiting examples of suitable shielding gases are carbon dioxide, argon, helium, oxygen, hydrogen, and nitrogen; mixtures of these may be used as the shielding gas. The preferred shielding gas composition generally depends upon the metal of the work piece.

The work piece may be, for example, any of steels, cast irons, aluminum alloys, copper alloys, nickel-based alloys, titanium alloys, and cobalt alloys.

FIG. 4 illustrates a representative response of a self-adjusting wire made with the shape-memory alloy to heat when the GMAW process is begun. A portion of self-adjusting wire 10 inside wire feeding pipe 32 and nozzle 22 is shown. An end 34 of the self-adjusting wire extends beyond nozzle 22. Before the GMAW process begins, the end 34 is bent and the self-adjusting wire is at a temperature below the phase transition temperature (e.g., the self-adjusting wire may be at room temperature). In this example, the centerline of the end 34 lies along line β, while the centerline of a straight wire would lie along line α, so that end 34 is bent at an angle θ. As the GMAW process begins, the end 34 of the self-adjusting wire is heated. The end 34 of the self-adjusting wire is eventually heated to above its phase transition temperature in the welding process, as it will be heated to its melting point as part of the GMAW process. In being so heated, the end 34 is heated above its austenite phase transition temperature so that any bend in the self-adjusting wire is straightened by the shape-memory alloy. As the end 34 of the self-adjusting wire passes through its phase transition temperature, the recovery stress induced by its shape-memory alloy will exceed the resistance of the deformed metal or metal alloy core, and consequently straighten the self-adjusting wire, so that wire end 34 moves from its position along line β to a straight position along line α.

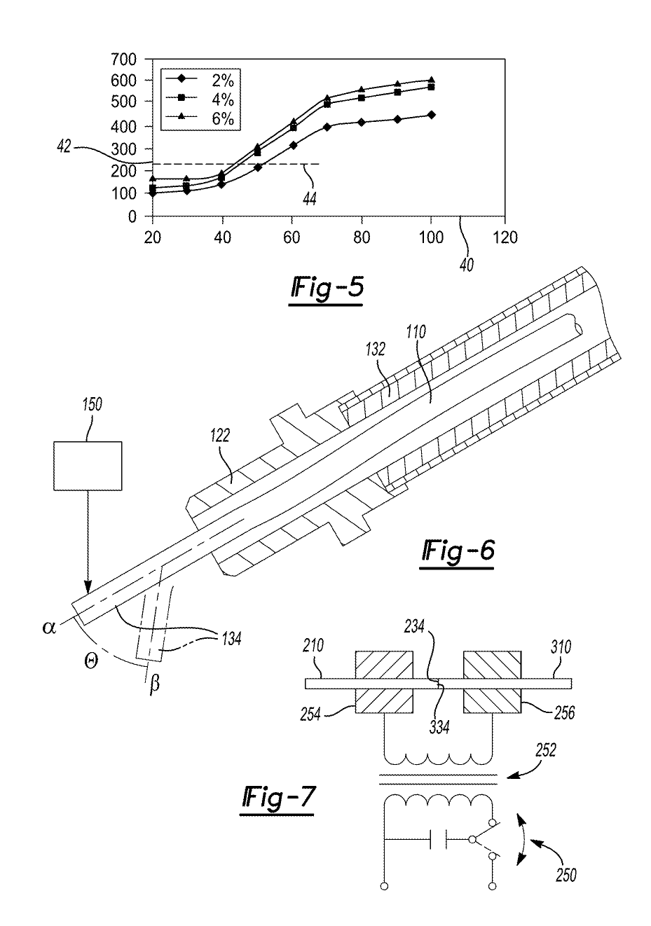

FIG. 5 is a graph providing one example of a self-adjusting wire using a TiNi shape-memory alloy. The graph has x-axis 40 of temperature in degrees C. and y-axis 42 of recovery stress in MPa. Dotted line 44 marks the yield strength of an aluminum core 12. Lines for a 2% strain, a 4% strain, and a 6% strain are plotted. The different strains represent different extents of bending of the self-adjusting wire. The graph of FIG. 5 shows that the higher the strain, the higher the recovery stress for the same shape-memory alloy as part of a self-adjusting wire for recovery stresses that can straighten the self-adjusting wire.

The self-adjusting wire may also be used in other thermal processes for joining metals. One example of a further thermal process for joining metal is laser welding or laser brazing. A laser may be employed to generate light energy that can be absorbed at a location in materials, producing the heat energy necessary to perform the welding operation. By using light energy in the visible or infrared portions of the electromagnetic spectrum, energy can be directed from its source to the material to be welded using optics, which can focus and direct the energy with the required amount of precision. After the applied light energy is removed, the molten material solidifies and then begins to slowly cool to the temperature of the surrounding material. Laser welding systems typically consist of a laser source, a beam delivery system, and a workstation. Carbon dioxide (CO₂) and Nd:YAG (neodymium-doped yttrium aluminum garnet) are two laser sources or laser media that may be used for laser welding applications. Both YAG and CO₂ lasers may be used for seam welding and spot welding of both butt joints and lap (overlap) joints. Solid state lasers (which includes Nd:YAG, Nd:Glass and similar lasers), are often employed in low- to medium-power applications, such as those needed to spot weld or beam lead weld integrated circuits to thin film interconnecting circuits on a substrate, and similar applications. In laser welding, a laser beam is applied to a top surface where two metal work pieces to be joined meet at a joint. At the same time, the self-adjusting wire is inserted into the top surface of the joint and melted to form a weld.

The self-adjusting wire that has a bent end at the start of a laser welding or laser brazing process may be heated to above its austenite phase transition temperature by heat from the laser to cause it to return to a trained unbent shape as illustrated in FIG. 6. FIG. 6 illustrates a representative response to heat of a self-adjusting wire 110 made with the shape-memory alloy when a laser welding process is begun. FIG. 6 shows a portion of self-adjusting wire 110 inside wire feeding pipe 132. An end 134 of self-adjusting wire extends beyond nozzle 122. Before the laser welding process begins, the end 134 is bent at a temperature below the martensite to austenite phase transition temperature (e.g., at room temperature). In this example, end 134 has an initial position with a centerline along line β that is bent at an angle θ from an orthogonal position that would have a centerline along line α. At the beginning of the laser welding process, the bent end 134 of self-adjusting wire 10 is heated by the laser 150 to a temperature above the austenite phase transition temperature of the trained shape-memory alloy. The heating to above the phase transition temperature causes the bent end 134 to straighten to its trained straight position along line α. This straightening of the end 134 of self-adjusting wire 110 with heat facilitates accurate wire placement into the joint. The self-adjusting wire may be fed by a wire feed unit such as wire feed unit 24 in FIG. 2. The diameter and feed rate of the self-adjusting wire will depend on the gap between the metal work pieces at the joint, the thickness of the metal work pieces, and their particular composition. As the metal work pieces are made thicker or the gap is made larger, a larger diameter self-adjusting wire is required, but the feed rate may be reduced.

Similarly, a process joining two metal work pieces in a lap joint may experience an alignment problem if the end of the welding wire is bent. The self-adjusting wire may again be straightened by being heated above its phase transition temperature, for example by a laser, in joining two work pieces by a lap joint.

The self-adjusting wire may likewise be used in other welding and joining processes that use wire and for other processes in which alignment is important, including arc brazing, TIG welding, wire-to-wire welding and wire threading in which heat may be used to straighten or align these self-adjusting wires.

FIG. 7 illustrates an embodiment in which the self-adjusting wire is used in wire-to-wire welding. Welding of wire ends is done in many technology areas. For example, in the wireless technology area, a high melting point rare metal wire and a nonferrous metal wire may be joined or dissimilar nonferrous metal wires may be joined (for example nickel wire and copper wire, silver wire and nickel wire, stainless steel wire and nickel wire, etc.). Other areas of technology rely on welding of wire ends as well, which wires may be of the same composition or different compositions. In each case, the shape-memory alloys may be selected in view of the metals or metal alloys used. For nickel wire cores, shape-memory alloy layers of Ni—Fe—Ga, Ni—Ti, Ni—Ti—Nb, Ni—Mn—Ga may be preferred. For copper wire cores, shape-memory alloy layers of Cu—Al—Ni, Cu—Zn, Cu—Zn—X may be preferred. For stainless steel wire cores, shape-memory alloy layers of Fe—Pt, Fe—Mn—Si may be preferred. Among various welding methods, the most common joining method is capacitor discharge projection welding, in which again the alignment of wire tips is very critical for successful joining. As shown in FIG. 7, an end 234 of a first self-adjusting wire 210 is welded to an end 334 of a second self-adjusting wire 310. Alignment of the wire ends 234 and 334 is critical to allowing proper welding to take place. Before being welded, at least one of ends 234 and 334 is bent and is straightened by being heated above its martensite to austenite phase transition temperature to cause the bent end to resume its trained straight shape. In the welding process, when switch 250 is closed transformer 252 causes a current to pass through ends 234 and 334 via electrical conductors 254, 256, which are used not only for fixing the two wires to be welded, but also can conduct electric current to the wires. Electrical conductors 254, 256 may be, for example, copper. In one embodiment, one of ends 234 and 334 that is bent is straightened by electrically connecting the end to both electrical conductors 254 and 256 and closing switch 250 to straighten the end by resistive heating to above its phase transition temperature.

The self adjusting wire may be also be used in other processes in which it is useful to straighten a bent wire end, for example where the wire must be threaded through an aperture. In such a process, a bent end of the self-adjusting wire is first heated to above its martensite to austenite phase transition temperature to cause the bent end to resume its trained straight shape, and then the straightened end is threaded through the aperture.

In various aspects, the present disclosure further provides a self-adjusting wire having a core of a metal or metal alloy and an outer layer of a shape-memory alloy. In certain aspects, the outer layer is continuous about the circumference of the core. In other variations, the outer layer is provided by one or more longitudinal strips of the shape-memory alloy attached to the core. In certain aspects, the shape-memory alloy may be a member selected from the group consisting of Cu—Al—Ni 14-14.5 wt. % Al and 3-4.5 wt. % Ni, Cu—Sn approx. 15 at. % Sn, Cu—Zn 38.5/41.5 wt. % Zn, Cu—Zn—X (wherein X=Si, Al, or Sn), Fe—Pt approx. 25 at. % Pt, Fe—Mn—Si, Co—Ni—Al, Co—Ni—Ga, Ni—Fe—Ga, Ti—Pd in various concentrations, Ni—Ti (about 55 at. % Ni), Ni—Ti—Nb, and Ni—Mn—Ga systems. In certain variations, the shape-memory alloy is a member selected from the group consisting of alloys of one or more of zinc, copper, gold, iron, aluminum, and nickel, optionally with other metals.

In other variations, the shape-memory alloy is a member selected from the group consisting of copper-zinc-aluminum-nickel alloys, copper-aluminum-nickel alloys, nickel-titanium alloys, iron-nickel alloys, iron-manganese-silicon alloys, and copper-zinc alloys. In further aspects, the core is steel and the shape-memory alloy is a member selected from the group consisting of Fe—Ni and Fe—Mn—Si alloys. In yet other variations, the core is aluminum and the shape-memory alloy is a member selected from the group consisting of Ti—Ni and Cu—Zn alloys.

Also provided is a method of straightening a bent end of a self-adjusting wire. The method comprises heating the self-adjusting wire, which comprises a core of metal or metal alloy and an outer layer of shape-memory alloy. The self-adjusting wire has a trained austenite phase straight shape, so that the heating is to above an austenite phase transition temperature whereby the self-adjusting wire straightens to its trained straight shape. In certain aspects, the method may further comprise positioning or aligning the straightened wire.

Furthermore, the present disclosure provides a method of thermally joining two metal articles using a self-adjusting wire comprising melting the self-adjusting wire into a seam between the two metal articles. The self-adjusting wire is trained to a straight shape in its austenite phase so that a bend in the self-adjusting wire straightens as the self-adjusting wire is heated above an austenite phase transition temperature. In certain aspects, the method of thermally joining two metal articles is a gas metal arc welding method. In other variations, the method is a laser welding method.

In yet other variations, the two metal articles are each, independently of one another, formed of a material selected from the group consisting of carbon steels, high-strength low alloy steels, stainless steels, aluminum, copper, and nickel alloys.

In certain aspects, the self-adjusting wire has a core of a metal or metal alloy and an outer layer of a shape-memory alloy. The self-adjusting wire may be at least one of the following combinations: (a) (1) a shape-memory alloy that is a member selected from the group consisting of Cu—Al—Ni 14-14.5 wt. % Al and 3-4.5 wt. % Ni, Cu—Sn approx. 15 at. % Sn, Cu—Zn 38.5/41.5 wt. % Zn, and Cu—Zn—X (wherein X=Si, Al, or Sn) and (2) at least one of the core and the two metal articles is a member selected from the group consisting of copper alloys and aluminum alloys; (b) a shape-memory alloy of Fe—Mn—Si and at least one of the core and the two metal articles is a member selected from the group consisting of steels; (c) a shape-memory alloy of Ni—Ti (about 55 at. % Ni) and at least one of the core and the two metal articles is a member selected from the group consisting of nickel-based alloys, aluminum alloys, steels, and cast irons; and (d) a shape-memory alloy of Ni—Ti—Nb and at least one of the core and the two metal articles is a member selected from the group consisting of nickel-based alloys, aluminum alloys, steels, and cast irons.

In further variations, the seam is a lap joint. Prior to the melting, the method optionally further comprises heating the self-adjusting wire to above its austenite phase transition temperature to straighten a bend in the self-adjusting wire, and then aligning the wire in the lap joint between the two metal articles.

The present disclosure also provides a method of welding an end of a self-adjusting wire. The method optionally comprises heating the self-adjusting wire. The self-adjusting wire is trained to a straight shape in its austenite phase. Thus, the heating takes the self-adjusting wire to above its austenite phase transition temperature to straighten a bend in the self-adjusting wire. Then an end of the straightened self-adjusting wire is abutted to an end of a second wire. The ends are then welded together. In certain variations, the self-adjusting wire and the second wire ends are welded by capacitor discharge projection welding.

In certain other variations, the self-adjusting wire has a core of a metal or a metal alloy and an outer layer of a shape-memory alloy. The self-adjusting wire may be selected from the group consisting of: (a) self-adjusting wires having nickel cores and shape-memory alloy selected from the group consisting of Ni—Fe—Ga, Ni—Ti, Ni—Ti—Nb, and Ni—Mn—Ga; (b) self-adjusting wires having copper cores and shape-memory alloy selected from the group consisting of Cu—Al—Ni, Cu—Zn, and Cu—Zn—X; and (c) self-adjustingwires having stainless steel cores and shape-memory alloy selected from the group consisting of Fe—Pt and Fe—Mn—Si.

Also provided in certain variations are methods for threading a wire through an aperture. The method may comprise providing a self-adjusting wire having a core of a shape-memory alloy and an outer layer of a metal or metal alloy. The self-adjusting wire is trained to a straight shape in its austenite phase. The method includes straightening a bent end of the self-adjusting wire by heating the wire to above its austenite phase transition temperature, followed by threading the straightened end through the aperture.

The foregoing description of certain embodiments has been provided for purposes of illustration and detailed description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A self-adjusting wire having a core of a metal or metal alloy and an outer layer of a shape-memory alloy.

2. A self-adjusting wire according to claim 1, wherein the outer layer is continuous about the circumference of the core.

3. A self-adjusting wire according to claim 1, wherein the outer layer is provided by one or more longitudinal strips of the shape-memory alloy attached to the core.

4. A self-adjusting wire according to claim 1, wherein the shape-memory alloy is a member selected from the group consisting of Cu—Al—Ni 14-14.5 wt. % Al and 3-4.5 wt. % Ni, Cu—Sn approx. 15 at. % Sn, Cu—Zn 38.5/41.5 wt. % Zn, Cu—Zn—X (wherein X=Si, Al, or Sn), Fe—Pt approx. 25 at. % Pt, Fe—Mn—Si, Co—Ni—Al, Co—Ni—Ga, Ni—Fe—Ga, Ti—Pd in various concentrations, Ni—Ti (about 55 at. % Ni), Ni—Ti—Nb, and Ni—Mn—Ga systems.

5. A self-adjusting wire according to claim 1, wherein the shape-memory alloy is a member selected from the group consisting of alloys of one or more of zinc, copper, gold, iron, aluminum, and nickel, optionally with other metals.

6. A self-adjusting wire according to claim 5, wherein the shape-memory alloy is a member selected from the group consisting of copper-zinc-aluminum-nickel alloys, copper-aluminum-nickel alloys, nickel-titanium alloys, iron-nickel alloys, iron-manganese-silicon alloys, and copper-zinc alloys.

7. A self-adjusting wire according to claim 1, wherein the core is steel and the shape-memory alloy is a member selected from the group consisting of Fe—Ni and Fe—Mn—Si alloys.

8. A self-adjusting wire according to claim 1, wherein the core is aluminum and the shape-memory alloy is a member selected from the group consisting of Ti—Ni and Cu—Zn alloys.

9. A method of thermally joining two metal articles using a self-adjusting wire comprising melting the self-adjusting wire into a seam between the two metal articles, wherein the self-adjusting wire is trained to a straight shape in its austenite phase so that a bend in the self-adjusting wire straightens as the self-adjusting wire is heated above an austenite phase transition temperature.

10. A method according to claim 9, wherein the method is a gas metal arc welding method.

11. A method according to claim 9, wherein the method is a laser welding method.

12. A method according to claim 9, wherein the two metal articles are each, independently of one another, of a material selected from the group consisting of carbon steels, high-strength low alloy steels, stainless steels, aluminum, copper, and nickel alloys.

13. A method according to claim 9, wherein the self-adjusting wire has a core of a metal or metal alloy and an outer layer of a shape-memory alloy and at least one of the following combinations is used:
(a) (1) a shape-memory alloy that is a member selected from the group consisting of Cu—Al—Ni 14-14.5 wt. % Al and 3-4.5 wt. % Ni, Cu—Sn approx. 15 at. % Sn, Cu—Zn 38.5/41.5 wt. % Zn, and Cu—Zn—X (wherein X=Si, Al, or Sn) and (2) at least one of the core and the two metal articles is a member selected from the group consisting of copper alloys and aluminum alloys;
(b) a shape-memory alloy of Fe—Mn—Si and at least one of the core and the two metal articles is a member selected from the group consisting of steels;
(c) a shape-memory alloy of Ni—Ti (about 55 at. % Ni) and at least one of the core and the two metal articles is a member selected from the group consisting of nickel-based alloys, aluminum alloys, steels, and cast irons; and
(d) a shape-memory alloy of Ni—Ti—Nb and at least one of the core and the two metal articles is a member selected from the group consisting of nickel-based alloys, aluminum alloys, steels, and cast irons.

14. The method according to claim 9, wherein the seam is a lap joint, wherein prior to the melting the method further comprises heating the self-adjusting wire to above its austenite phase transition temperature to straighten a bend in the self-adjusting wire, and then aligning the wire in the lap joint between the two metal articles.

15. A method of welding an end of a self-adjusting wire comprising heating the self-adjusting wire, wherein the self-adjusting wire is trained to a straight shape in its austenite phase, to above its austenite phase transition temperature to straighten a bend in the self-adjusting wire, then abutting an end of the straightened self-adjusting wire to an end of a second wire and welding the ends together.

16. A method according to claim 15, wherein the self-adjusting wire and the second wire ends are welded by capacitor discharge projection welding.

17. A method according to claim 15, wherein the self-adjusting wire has a core of a metal or a metal alloy and an outer layer of a shape-memory alloy and is selected from the group consisting of:
(a) self-adjusting wires having nickel cores and shape-memory alloy selected from the group consisting of Ni—Fe—Ga, Ni—Ti, Ni—Ti—Nb, and Ni—Mn—Ga;
(b) self-adjusting wires having copper cores and shape-memory alloy selected from the group consisting of Cu—Al—Ni, Cu—Zn, and Cu—Zn—X; and
(c) self-adjusting wires having stainless steel cores and shape-memory alloy selected from the group consisting of Fe—Pt and Fe—Mn—Si.
